(19) United States
(12) Patent Application Publication
(10) Pub. No.: US 2018/0336759 A1
(43) Pub. Date: Nov. 22, 2018

(54) APPARATUS AND METHODS SIMULATING PROJECTILE BODY MOVEMENTS

(71) Applicant: TGG Interactive Limited, Hong Kong (HK)

(72) Inventors: Yui Man Raymond Chan, Hong Kong (HK); Ka Lun Ernie Suek, Hong Kong (HK); Ka Chun Lam, Hong Kong (HK)

(21) Appl. No.: 15/981,880

(22) Filed: May 16, 2018

(30) Foreign Application Priority Data
May 16, 2017 (HK) 17104926.2

(51) Int. Cl. G07F 17/32; G07F 17/38

(52) U.S. Cl. CPC G07F 17/3213; G07F 17/3253; G07F 17/38

(57) ABSTRACT

A pachinko machine having a simulated stage, a simulated launcher and a simulated ball or simulated balls which are to appear on a display screen of an electronic display device upon execution of instructions by a microprocessor; wherein the simulated stage is partitioned into an entry region, an exit region and an intermediate region interconnecting the entry region and the exit region; wherein the simulated ball after entry into the simulated stage is to transit from the entry region to the exit region following a transition path; wherein the transition path is one of a plurality of transition paths available and the transition paths are associated with transition probabilities which are defined in a transition matrix.

### CROSS REFERENCE TO RELATED APPLICATIONS

The present application claims the benefit of Hong Kong Patent Application No. 17104926.2 filed on May 16, 2017. All the above are hereby incorporated by reference.

### FIELD

The present disclosure relates to methods and apparatus of simulated moving objects such as simulated projectiles, and more particularly, to methods and apparatus for controlling movements of movable objects bodies when subject to simulated launching.

### BACKGROUND

A movable body when subject to an upward propelling force will travel along a trajectory path due to gravitation force. A travelling movable body when encountering an obstacle will be deflected to travel at a changed direction. The aforesaid and other physical phenomena are widely used in combination to devise gaming machines which are known as pachinko machines. In a pachinko machine, steel balls are launched from a spring driven launcher and move into a stage comprising many obstacles and accessories. The steel balls are projected as projectiles into the stage and will trigger many events upon encountering the obstacles and accessories. While pachinko machines provide much fun and enjoyment to people, improvements in pace with modern world technology are desirable.

### DISCLOSURE

A machine comprising a processor, a display device, a data storage device and a user interface and a method of devising a pachinko machine on the machine is disclosed. The processor is to execute stored instructions to generate a simulated scene on the display device as a simulated playing field, wherein the simulated scene is divided into an entry region, an exit region and an intermediate region interconnecting the entry region and the exit region; wherein the entry region comprises a plurality of entry cells, the exit region comprises a plurality of exit cells, and the intermediate region comprises a plurality of intermediate cells; and to generate one simulated object or a plurality of simulated objects on the display device, to launch a simulated object into the entry region as a launched object and to move the launched object through the intermediate region and then to exit via or on traversing through the exit region. The processor is to execute stored instructions to move the launched object into one of the plurality of entry cells, wherein each entry cell has an associated entry probability which is predetermined and the plurality of entry cells has a sum of entry probabilities equals to one; wherein the launched object is to move through the simulated scene in one of a plurality of predetermined transition paths and each transition path is defined by a plurality of field cells each having associated incoming probabilities and outgoing probabilities which are predetermined; and wherein the incoming probabilities and outgoing probabilities are preset or prescribed in a predetermined transition probability matrix.

A machine comprising a processor, a display device operated by the processor, a data storage device and a user interface connected to the processor for detection of user commands; and a method of operating the machine is disclosed. The processor is to execute stored instructions to generate a simulated scene on the display device, the scene comprising a plurality of scene cells and each cell having an associated obstacle device and a transition probability including an incoming probability and an outgoing probability; wherein the scene cells are grouped into a first plurality of entry layer cells forming an entry layer, a second plurality of intermediate layer cells forming an intermediate cell layer, and a third plurality of end cells forming an end layer; to generate one simulated movable body or a plurality of movable bodies on the display device but outside the scene, to launch the movable body into an entry layer cell upon detection of a launching signal at the user interface, and to move the movable body from the entry layer cell, through the intermediate cell layer, to the end cell following a predetermined transition path to traverse across the stage; and to generate path deflection when the movable body encounters an obstacle associated with a cell.

The predetermined transition path is one of a plurality of available transition paths between the entry layer cell and the end cell, and the likelihood that the movable body will move along a specific available transition path when transiting from the entry layer cell and the end cell is governed by probabilities set out in a predetermined transition probability matrix.

In some embodiments, each one of the first plurality of entry layer cells forming the entry layer has a predefined associated incoming probability, the incoming probability associated with a specific entry layer cell defining a likelihood that a movable body upon launch will land in that specific entry layer cell, and sum of the incoming probabilities associated with all entry layer cells being unity; and wherein the associated incoming probability is influenced by user's selection of launching parameters.

In some embodiments, the launching parameters include angle of launch and launching force.

In some embodiments, each launch has an associated pay-in amount and each cell has an associated payout rate, and the payout rates of the cells forming the stage are predetermined.

In some embodiments, the transition probability and the payout rates of the cells cooperate to define a RTP.

In some embodiments, the transition probabilities of all the cells are arranged in the form of a transition probability matrix and the payout rates of all the cells are arranged in the form of a payout matrix, wherein the total RTP is obtained by multiplying the transition probability matrix and the payout matrix or its transpose.

In some embodiments, the machine is to simulate stage, scenes and operations of a pachinko machine and the processor is to generate simulated trajectory movement paths of the movable bodies, said trajectory movement paths not following paths of a weighted body under influence of gravity.

In some embodiments, the incoming probabilities and the outgoing probabilities are predetermined and saved in the data storage device before triggered operations.

In some embodiments, the user interface includes a simulated launching device, the simulated launching device being outside the stage and being operable to launch one movable body or a plurality of movable bodies into the stage.

In some embodiments, the movable bodies are to appear as simulated steel balls and the obstacles include simulated metal bosses, metal pillars or metal bolts in the stage.

The predetermined transition path is one of a plurality of available transition paths between the entry layer cell and the end cell, and the likelihood that the movable body will move along a specific available transition path when transiting from the entry layer cell and the end cell is governed by probabilities set out in a predetermined transition probability matrix.

In some embodiments, the processor is to generate angular path deflection when the movable body encounters a simulated obstacle which is associated with a cell.

### FIGURES

The present disclosure will be described by way of example and with reference to the accompanying Figures, in which:

FIG. 1 is block diagram of an example machine according to the present disclosure,

FIG. 2 is a schematic diagram of an example layout of field cells and other background scene cells as well as an example launcher on a display screen of an example machine of FIG. 1,

FIG. 3A is a schematic diagram of an example launcher of the machine comprising a shooting angle controller as appearing on the display screen of the machine of FIG. 1,

FIG. 3B is a schematic diagram of a launching device as appearing on the display screen of the machine of FIG. 1,

FIG. 4A is a schematic diagram showing angular adjustment of the shooting angle controller of FIG. 3A,

FIG. 4B is a schematic diagram showing shooting angle of an example launching device,

FIG. 5A shows an example layout of an example blank stage of a machine according to the present disclosure,

FIG. 5B is a schematic diagram depicting probability distribution associated with the various cells which form the blank stage of FIG. 5A,

FIG. 5C shows example movement of balls and example scenes formed on the blank stage of FIG. 5A,

FIG. 5D shows example stage of FIG. 5A with an example shooter (cannon) and controller distributed respectively on upper right and lower right corners,

FIGS. 6A to 6D show a series of movement of a ball moving through an example stage, and

FIGS. 7A to 7J show a series of movement of a plurality of balls moving through an example stage,

FIG. 8 shows an example stage of an example machine, FIGS. 8A, 8B and 8C are schematic diagrams showing example movement of a ball, and

FIG. 8D shows an example layout of the filled matrix of the stage of the machine of FIG. 8.

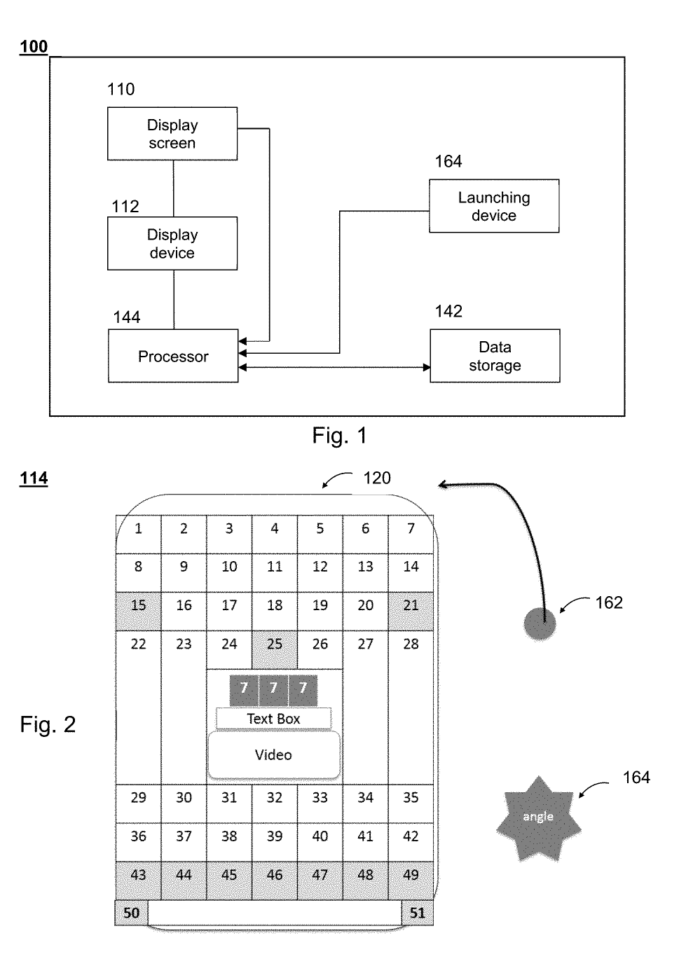

### DESCRIPTION

An example apparatus 100 comprises a display device 112 having a display screen 114, a data storage device 142, a processor 144 and a user interface 164. The example apparatus 100 is a floor-standing gaming apparatus which is commonly known as an arcade machine and which may be installed for entertainment operations in a casino or other establishments. In some embodiments, the example apparatus 100 may be a hand-held or portable machine. In some embodiments such as the present, components of the apparatus are housed within a floor-standing rigid housing and a user can operate the apparatus with either a single hand or with both hands. The example display device 112 comprises a high-resolution LCD display screen which forms a high-resolution LCD display surface. The example display screen is driven by a high-speed graphic display card. The data storage device 142 includes volatile and/or non-volatile memory devices for data and instruction storage. The processor 144 is to function as a machine controller and a processor of the present apparatus may comprise a single microprocessor or a cluster of microprocessors. A microprocessor herein may be a single-core microprocessor or a multi-core microprocessor. The example user interface 164 in the form of a launching device and may be a push button, a mouse, a joystick. In some embodiments such as the present, the user interface 164 is soft configured on a touch panel which is part of the display screen.

In use, the processor 144 is to execute a set of stored instructions using a set of scene-setting data to devise and display a simulated scene on the display screen. The set of stored instructions may be stored in the non-volatile memory such as a hard disk as a software file or an application software (“APP”). The example apparatus 100 is a simulated pachinko machine which is to simulate a pachinko machine and the simulated scene is to resemble the scene of an example pachinko machine.

A conventional pachinko machine is a mechanical gaming machine involving movement of pachinko balls inside the machine. A typical pachinko machine comprises a substantially vertical playing surface (“field surface”) on which a scenic playing field is devised. The field surface is populated with a plurality of obstacles and the obstacles are distributed within the field surface to define a plurality of movement paths along which a pachinko can move. A conventional pachinko machine comprises a plurality of pachinko balls and a launcher to launch the pachinko balls into the playing field. When the launcher is triggered, a pachinko ball is projected upwards by the launcher and moved into the playing field with an entry angle and an entry speed. The entry angle and the entry speed are dependent on a number of factors, including the launching speed of the launcher, the lunching path of the launcher and skill of a player. A pachinko ball once moved into the playing field will move generally downwards through the playing field and transit from an entry region to an exit region via an intermediate region. The pachinko ball on encountering an obstacle will be deflected and the transit paths are defined by the obstacles. An obstacle typically comprises a brass pin or a group of brass pins which projects orthogonally outwards from the field surface. The obstacle is rigid so that when a moving pachinko ball encounters the obstacle in a head-on manner, reaction due to encountering collision will change the course of movement (and hence the movement or hopping path) of the pachinko ball. The exit region is usually on the lowest portion of the playing field and a pachinko ball is to exit through the exit region when it has lost momentum at the end of its journey through the playing field. A pachinko ball is usually a metallic ball so that it has a sufficiently high momentum to travel through the playing field.

The example apparatus 100 is to simulate a conventional pachinko machine while having novel, un-conventional and useful features. The description of a conventional pachinko machine is incorporated herein by reference and the features and description of a conventional pachinko machine are to apply mutatis mutandis.

The simulated scene (or scene in short) comprises a background scene which defines a playing field and a field surface. The playing field is set to be substantially vertical or inclined at a small angle or an acute angle to the vertical. A plurality of simulated obstacles is populated inside the playing field and the simulated obstacles are distributed to define a plurality of transitional paths. The simulated obstacles appear rigid and are scattered within the playing field to provide a system of distributed deflection means for deflecting the simulated pachinko balls within the playing field. The playing field is laid out and the simulated obstacles are distributed such that a plurality of predefined paths is available for the simulated pachinko balls to move along. The example obstacle comprises one simulate metal pin or a plurality of simulate metal pins forming a group of obstacle pins which projects orthogonally away from the field surface.

The simulated pachinko machine is devised to have the look-and-feel of a conventional pachinko machine. In this regard, the simulated pachinko machine comprises a simulated launcher for launching one simulated pachinko ball or a plurality of simulated pachinko balls into the simulated playing field. A simulated pachinko ball launched by the simulated launcher is to follow a simulated trajectory path of a projectile, such as the trajectory of a pachinko ball of a conventional pachinko machine. The simulated pachinko ball is to be projected at an entry angle and at an entry speed into the playing field and to move under the apparent influence of gravity through the simulated playing field. Once injected into the playing field, the simulated pachinko ball will be confined to move inside the playing field until its exit from the playing field.

The playing field extends transversely to define a width and longitudinally to define a length. The playing field comprises an entry region, an exit region and an intermediate region interconnecting the entry region and the exit region.

The entry region is the first region of the playing field that a simulated pachinko ball will encounter upon moving into the playing field after launch. The entry region is situated at and forms the uppermost portion of the playing field and a simulated pachinko ball will move downwards towards the exit region after entering the first region of the playing field. An example entry region defines the uppermost region of the playing field and is formed by a plurality of adjacently abutting entry cells which are inter-linked or interconnected in a sidewise manner. The entry region defines the foremost boundary of the playing field and is a region which determines the actual admission location of a simulated pachinko ball int the playing field.

The exit region is the last region of the playing field that a simulated pachinko ball will encounter before leaving the playing field. The exit region is situated at and forms the lowermost portion of the playing field. An example exit region defines the lowermost region of the playing field and is formed by a plurality of adjacently abutting entry cells which are inter-linked or interconnected in a sidewise manner. The exit region defines the rearmost boundary of the playing field and is a region which determines the actual departure location of a simulated pachinko ball from the playing field.

The intermediate region is situated intermediate the entry region and the exit region. The intermediate region may comprise one intermediate layer or a plurality of intermediate layers. Each intermediate layer comprises a plurality of intermediate cells and adjacent Intermediate cells of an intermediate layer are inter-linked or interconnected in abutment in a sidewise manner. Each simulated pachinko ball is to transit through the intermediate region after entering and before leaving the playing field.

The playing field is partitioned into a plurality of field cells and a field cell can be an entry cell, an exit cell or an intermediate cell. An entry cell is also referred to as an entry region cell, an exit cell is also referred to as an exit region cell and an intermediate cell is also referred to as an intermediate region cell.

Movement of the pachinko balls inside the playing field are to resemble movement of real pachinko balls. For example, the simulated pachinko balls are to hop from one obstacle to the next obstacle on transiting between adjacent cells to resemble hopping of real pachinko balls on encountering real obstacles. The hopping is to resemble projectile motion of a real pachinko ball.

Contrary to the purely mechanical induced movement of a conventional pachinko machine, the movements or movement paths of a simulated pachinko ball across or within the playing field are governed by a set of probabilities.

The entry region is formed by a plurality of entry cells and each entry cell has a predefined incoming probability such that a sum of the incoming probabilities of the plurality of entry cells forming the entry region equals one or 100%. This means a simulated pachinko ball must enter the playing field through one of the plurality of entry cells forming the entry region.

After a simulated pachinko ball has entered an entry cell, the next or onward movement of a simulated pachinko ball from an entry cell is governed by a set of out-going probabilities. The set of outgoing probabilities associated with an entry cell defines the likelihoods in relation to which one of the next available intermediate cells in the intermediate layer the simulated pachinko ball will move into after exiting the entry cell. The outgoing probabilities of a given entry cell have a sum of one or 100% which means that the simulated pachinko ball must move on to an intermediate cell.

The intermediate cells which are available for hopping by a simulated pachinko ball which is currently in an entry cell have a set of incoming probabilities associated with that entry cell, and a sum of the incoming probabilities equals one or 100%.

Where the intermediate region comprises a plurality of intermediate layers, the intermediate cells which are available for hopping by a simulated pachinko ball which is currently in an intermediate cell of another intermediate layer (an upstream intermediate layer) have a set of incoming probabilities associated with that intermediate cell and a sum of the incoming probabilities equals one or 100%.

The exit cells which are available for hopping by a simulated pachinko ball which is currently in an intermediate cell have a set of incoming probabilities associated with that intermediate cell, and a sum of the incoming probabilities equals one or 100%.

Movement of a simulated pachinko ball across the playing field is governed by a transition matrix which sets out the various transition probabilities.

To resemble operation of a conventional pachinko machine, movement of a simulated pachinko ball inside the playing field is devised by the processor to resemble movement of a real pachinko ball under the influence of gravitational force.

In some embodiments, a field cell (known as a bonus cell) may carry an award or a special bonus. An award or a special bonus will be made out to the player if the simulated pachinko ball reaches or transits through the bonus cell. The bonus cell may be an entry cell, an exit cell and/or an intermediate cell. As each field cell has an associated incoming probability, the probability of reward or bonus is associated with the incoming probability.

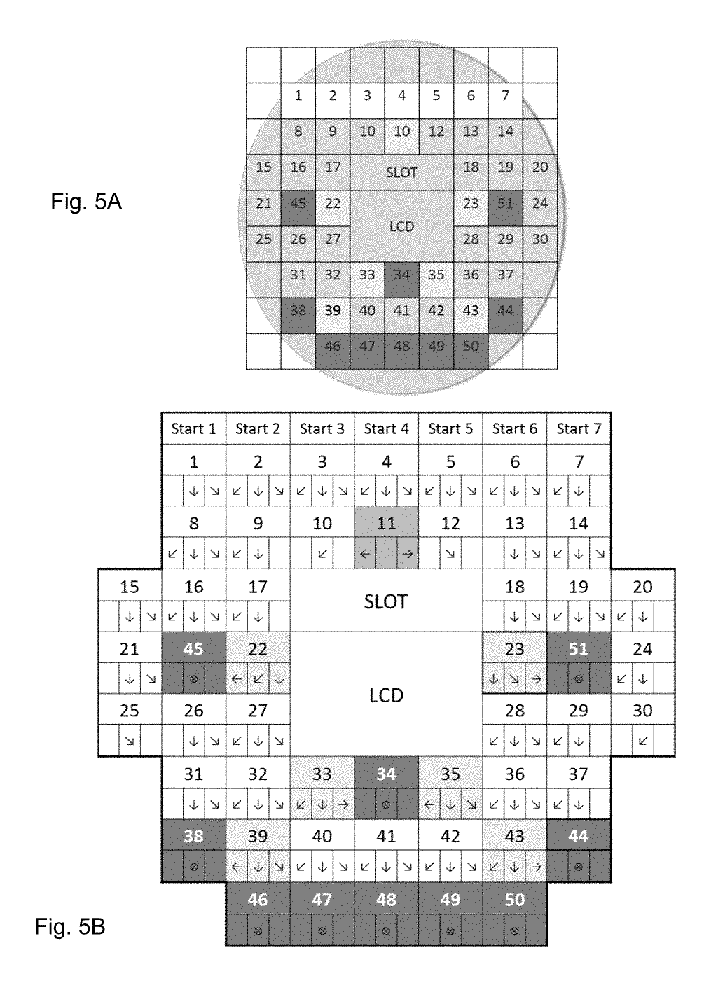

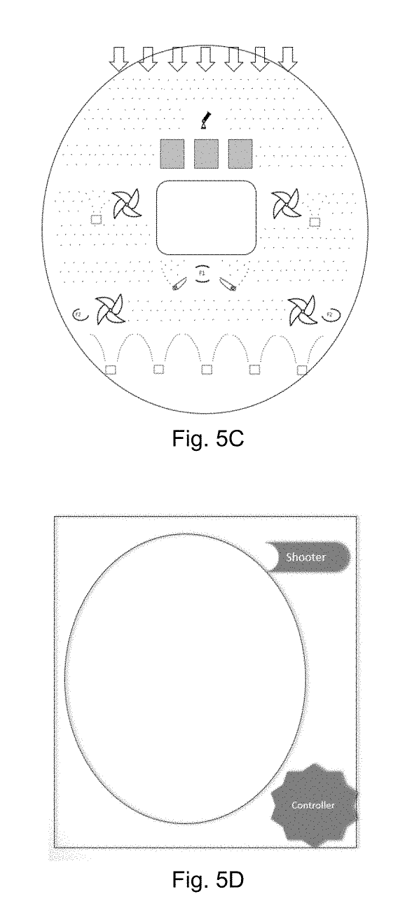

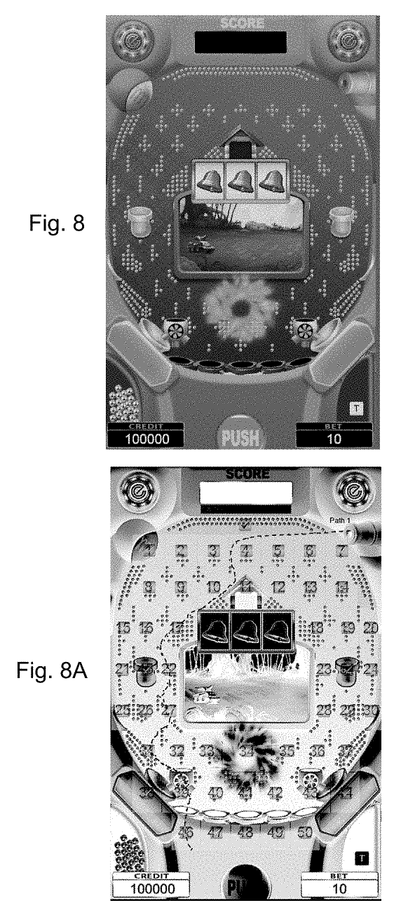

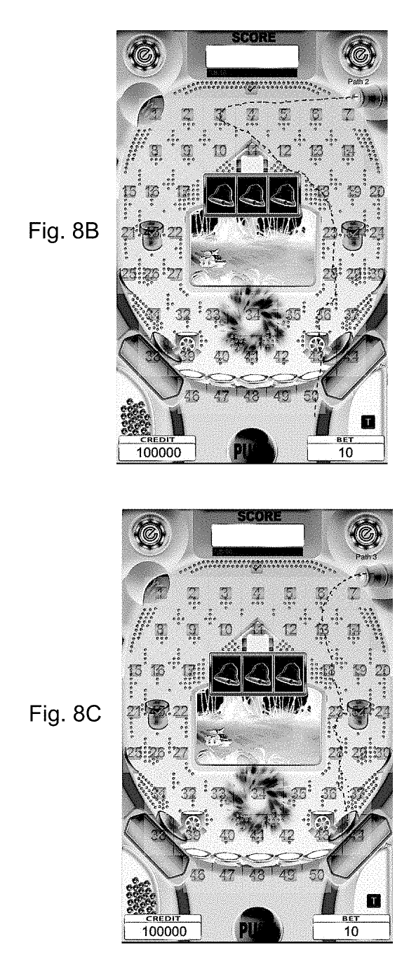

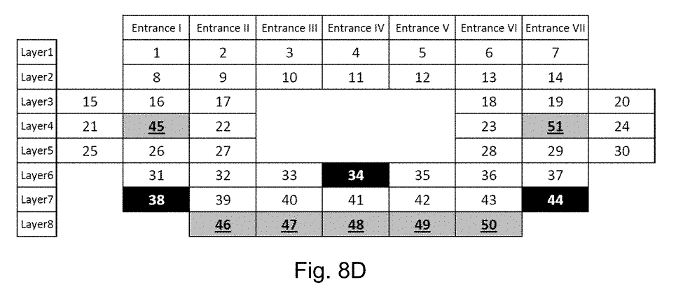

An example display screen 114 of an example gaming apparatus 100 is depicted in FIG. 2. The display screen 114 comprises a schematic playing field 120 which is schematically partitioned into an example plurality of fifty-one field cells. Each field cell (or “cell” in short) is assigned a unique identification number between 1 and 51. The cells are arranged into a matrix of eight rows and seven columns, with seven cells in each row except the last row which has only two cells. The rows have the same width and height (except some cells in the fourth and last rows), and are lateral-edge aligned, so that the example background stage has a substantially rectangular shape. A text box, a video screen and a triple-slot are present between the fourth row and the fifth row. The cell numbers are shown for identification and for ease of reference only and are not shown on the display screen during actual gaming operations. During gaming operations, the processor is to execute store instructions to turn the field cells into graphic cells or scene cells and the playing field will become a pachinko stage having an aesthetically pleasing scenic or graphic backdrop. Each one of the field cells has an associated obstacle which is to operate as a movement deflection device, as depicted in the example scenes of FIGS. 5C and 8. An obstacle may comprise one simulated metal pin or a group of simulated metal pins as a simulated pin assembly. Each simulated metal pin is to protrude orthogonally away from the stage surface but would appear as a shiny or conspicuous dot or object such as a metal boss on the stage surface. The pins are steel-like to provide a rigid look, feel and impression to a player so that a player will have a reflexive perception that an on- coming simulated pachinko ball will be deflected and bounced away to move along a deflected path upon encountering the obstacle.

The example playing field 120 comprises a first row which is an entry row defining the entry region or the entry layer of the playing field. Each simulated pachinko ball has to or can only enter the playing field through one of the entry cells according to an example design. A simulated pachinko ball herein is an example of a simulated moving object or a simulated projectile. The entry row comprises an example plurality of seven entry cells numbered one to seven, as depicted in FIG. 2.

The example playing field 120 comprises an exit region which is defined by an example plurality of nine exit cells. The exit region, which defines an exit layer, consists of field cells which are numbered 43 to 51. The exit cells are arranged into two exit rows, namely the 7^{th} row and the 8^{th} row of the field matrix. Each simulated pachinko ball has to or can only exit the playing field through one of the exit cells according to an example design.

The example playing field 120 comprises an intermediate region which consists of an example plurality of five intermediate rows and an example plurality of thirty-five intermediate cells, numbered 8 to 42. The intermediate rows define intermediate layer and each intermediate row consists of an example plurality of seven intermediate cells. The intermediate cells have identical width and the intermediate cells are organized into a rectangular matrix of intermediate cells, or intermediate field matrix. The intermediate rows have identical length or depth in the longitudinal direction except for the third intermediate row which consists of intermediate cells numbered 22 to 28. The third intermediate row is disposed approximately in the middle portion of the display screen where ancillary display, such as a video display and jackpot display are located.

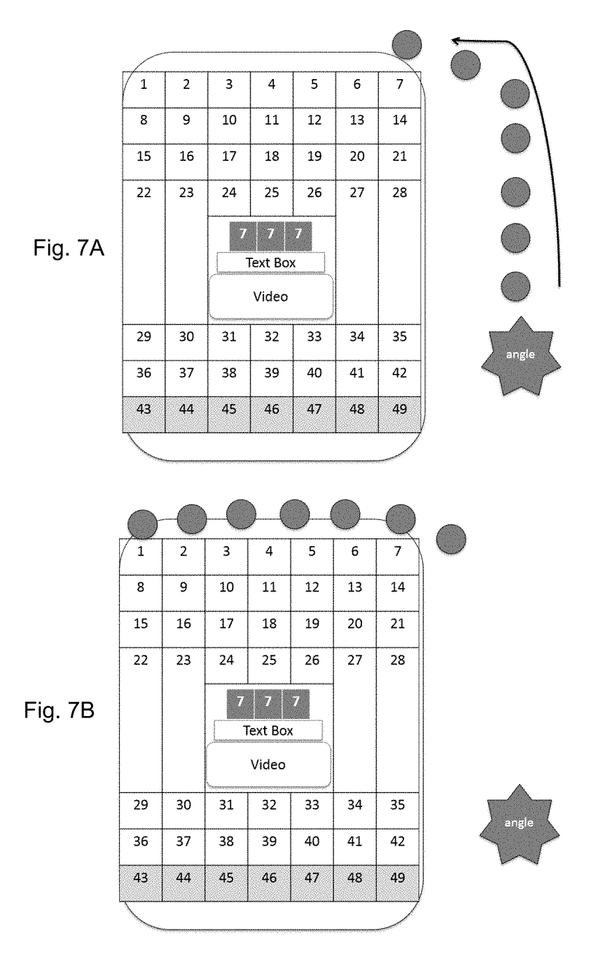

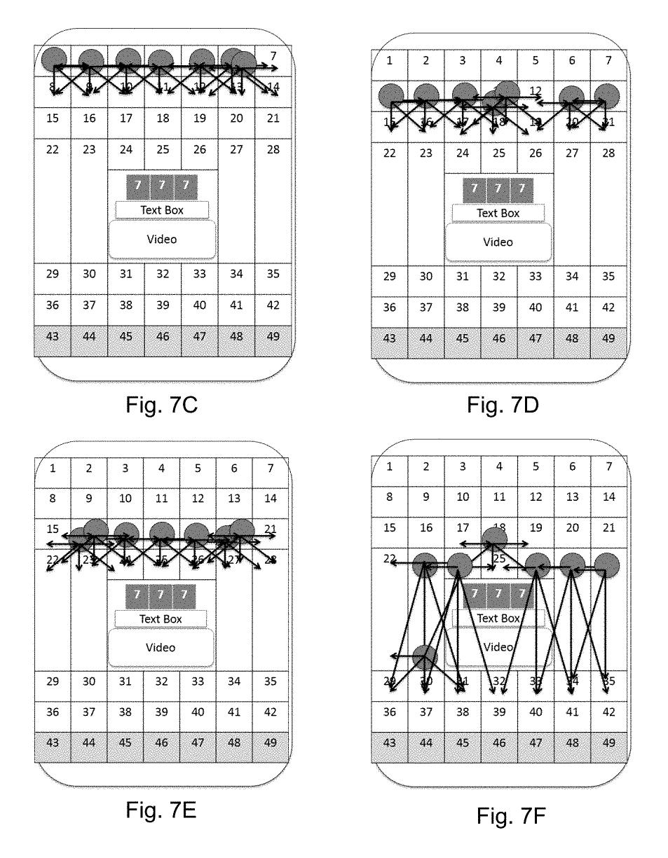

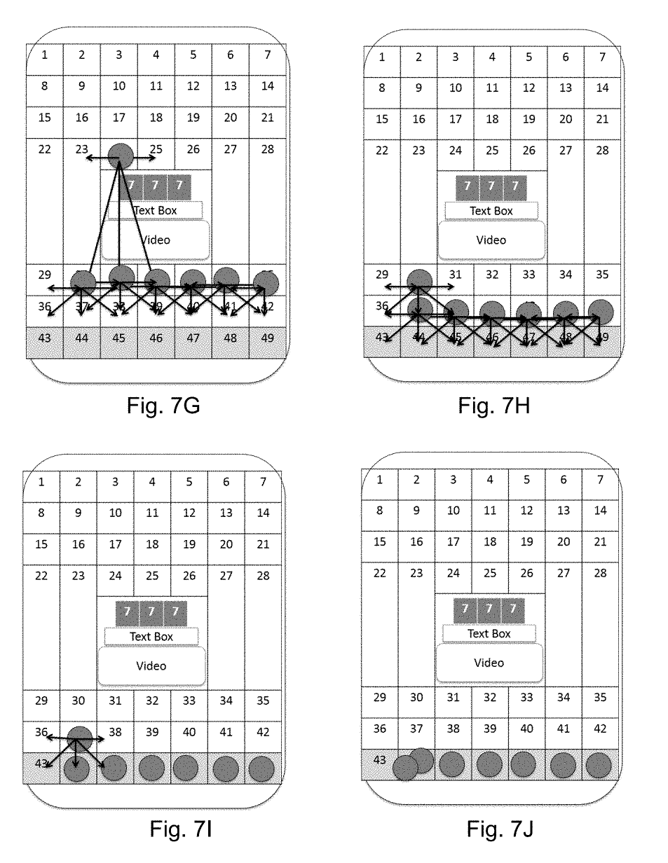

In an example playing field 120A, the exit region and the exit layer is defined by a single row of exit cells, numbered 43 to 49, as depicted in FIG. 7A. The exit row is the last row of the field matrix and consists of seven exit cells.

A launching device 164 is display on the display screen 110 and located outside the stage, that is, the playing field 110. The example launching device 164 is a simulated launching device and a controller icon is displayed on the display screen 110. The display screen 110 is a touch panel so that a user can operate the launching device 164 by way of interactively touching the display screen 110. The launching device 164 is operable to launch a simulated movable body 162 into the playing field. In some embodiments such as the present where the machine is a simulated pachinko machine, the movable body 162 is a pachinko ball. Since the scene and the devices including the controller and the movable body are simulated and generated by operation of the processor, they may be modified or updated from time to time by the processor executing stored instructions without loss of generality. In some embodiments, the launching device and the movable body may be real, physical or non-virtual devices.

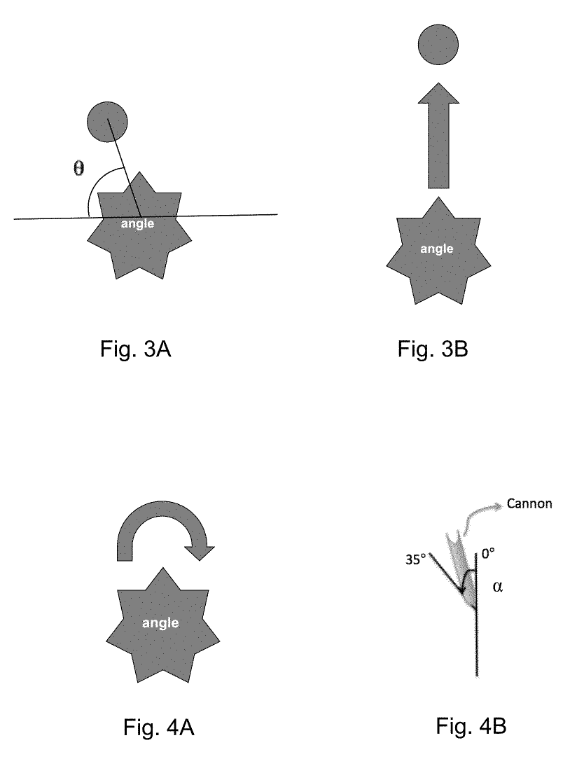

The launching device is an example device which is to serve as a user interface to enable a user to interact with the gaming machine. More specifically, the launching device is to operate as a launching controller which is operable by a user to initiate or activate operation of the machine 100. In example embodiments, the launching device may have an angular launching control as depicted in FIGS. 3A and 3B. In some embodiments, the launching device may have an adjustable power level or an initial impulse level control so that the initial momentum to imparted to a movable body to be injected into the playing field can adjusted or selected or controlled by the user.

The example machine 100 and the example simulated stage are arranged and generated for display, for example, by pre-programming of the processor according to pre-determined rules. n some embodiments such as the example of FIG. 2, a simulated pachinko ball 162 that is to be ejected into the stage by the launching device will follow a predetermined path resembling the trajectory of a real pachinko ball to enter the stage. When the ball 162 enters the stage, it will encounter an entry cell which is on the outermost periphery of the stage. In the example of FIG. 2, the ball is projected upwards by the launching device upon activation by a user and the ball will move upwards and away from the stage following a simulated trajectory-like path. After reaching the peak of the simulated trajectory path, which is at a vertical level above the stage, the ball 162 will turn and move downwards towards the entry region of the stage. As the ball enters the stage from above or outside the stage, the ball 162 will land in one of the entry cells in the first row. The first row of the stage is the uppermost row on the outermost periphery of the stage in this example.

While the ball 162 must land on an entry cell in order to enter the stage, on which particular entry cell a ball 162 will land is dependent on the probability associated with that particular entry cell. Each entry cell is assigned an incoming probability and the sum of incoming probabilities of all the entry cell equals one so that a ball 162 must land on one of the entry cells after launch. In some embodiments, the incoming probability assigned to a specific entry cell is predetermined and fixed. In some embodiments, the incoming probability assigned to a specific entry cell is dependent on the launching angle and the launching speed which determines the initial momentum imparted to the ball 162.

In some embodiments, the incoming probabilities are pre-assigned and related to the launching angle. For example, the controller may launch a ball 162 within an angular range a which is between α₁ and α₂ to the vertical and the angular range may be divided into a plurality of angular steps. For example, the example launcher may launch between an angular range a which is between α₁=0 and α₂=35° and the example angular range is divided into an example plurality of seven angular levels at an example angular interval of 5°, as set out in Table 1 below.

TABLE 1

| Entry | | | | | | | |
|---|---|---|---|---|---|---|---|
| Cell | | | | | | | |
| No. | 0°~5° | 6°~10° | 11°~15° | 16°~20° | 21°~25° | 26°~30° | 31°~35° |
| 1 | 41.67% | 14.63% | 11.36% | 8.89% | 6.82% | 4.88% | 2.78% |
| 2 | 16.67% | 36.59% | 13.64% | 11.11% | 9.09% | 7.32% | 5.56% |
| 3 | 13.89% | 14.63% | 34.09% | 13.33% | 11.36% | 9.76% | 8.33% |
| 4 | 11.11% | 12.20% | 13.64% | 33.33% | 13.64% | 12.20% | 11.11% |
| 5 | 8.33% | 9.76% | 11.36% | 13.33% | 34.09% | 14.63% | 13.89% |
| 6 | 5.56% | 7.32% | 9.09% | 11.11% | 13.64% | 36.59% | 16.67% |
| 7 | 2.78% | 4.88% | 6.82% | 8.89% | 11.36% | 14.63% | 41.67% |
| Total | 100% | 100% | 100% | 100% | 100% | 100% | 100% |

For example, if a player chooses to launch a ball at 27° to the vertical, the launch angle a to the vertical falls into the sixth angular group of “26°˜30°”. There is a probability (incoming probability) of 4.88% that the ball will land on cell 1, a probability of 7.32% on cell 2, a probability of 9.76% on cell 3, a probability of 12.2% on cell 4, a probability of 14.63% on cell 5, a probability of 36.59 on cell 6, and a probability of 14.63% on cell 7. Therefore, it is most likely that the ball will land on cell 6, although the ball may land on other entry cells according to design.

In some embodiments, the incoming probability may depend on the launching force level in combination with the launching angle and Table 1 may include force levels without loss of generality.

In general, a cell having a higher incoming probability will have a better prospect of receiving a ball and will receive more balls in the long run and a cell having a lower incoming probability will have a poorer prospect of receiving a ball and will receive a lesser number of balls in the longer. Where a cell has a zero incoming-probability, the cell will be a deserted cell with no chance of receiving an incoming ball on entry or on transit.

In some embodiments, the machine is set for skilled game playing and has predefined RTP (return-to-player) which is related to the incoming probabilities as follows:

RTP(overall)=ΣᵢRTP(OP(i), where RTP(i) and P(i) are, respectively, the RTP and incoming probability assigned to entry cell i.

The overall RTP (RTP(overall) has a value which is within an RTP range. The RTP range has a value which is between [Min RTP, Max RTP], where Min RTP=Minimum (RTP(0°˜5°), RTP(6°˜10°), RTP(11°˜15°), RTP(16°˜20°), RTP(21°˜25°), RTP(26°˜30°), RTP(31°˜35°); and Max RTP=Maximum (RTP(0°˜5°), RTP(6°˜10°), RTP(11°˜15°), RTP(16°˜20°), RTP(21°˜25°), RTP(26°˜30°), RTP(31°˜35°) in this example.

After entry into the stage, the ball 162 will travel along an onward path which is one of a plurality of available paths set by the processor. The example available onward paths are predefined routes which are apparently defined by the locations of the obstacles but are actually preset set by the processor according to design. The available paths are related to the field cells and each field cell has associated or assigned incoming and outcoming probabilities.

Assuming for the sake of simplicity that the field matrix of cells has an example plurality of nine cells which are arranged into three rows and three columns, as depicted in table 1 below, in which cells numbered 1, 2, 3 are on the first row, cells numbered 4, 5, 6 are on the second row, and cells numbered 7, 8, 9 are on the third row, and the balls are to fall on from above.

TABLE 2

| | | | |
|---|---|---|---|
| Layer 1 | 1 | 2 | 3 |
| Layer 2 | 4 | 5 | 6 |
| Layer 3 | 7 | 8 | 9 |

In this example, the first row is an entry layer and all balls entering the stage defined by the nine cells must enter the entry layer first, the third row is a final layer or the exit layer where all the balls must leave the stage and stop, and the second row is an intermediate layer through which every ball moving from the entry layer to the final layer must transit. In this example, the intermediate region consists of a single intermediate row.

After a ball has entered the entry layer and landed in an entry cell of the entry layer, it will continue to move onwards towards the final layer. On the simulated stage, the simulated onward movement will appear as resulting from residual momentum of the ball on encountering an obstacle, and the symbols shown below in Table 2 will be used to indicate movement orientations for ease of reference:

TABLE 3

| Symbol | [symbol] | ↓ | [symbol] | ⊗ |
|---|---|---|---|---|
| Meaning | Left-Down | Down | Right-Down | Stop |

An example probability allocation for the example stage matrix of Table 2 is set out in Table 4 below.

TABLE 4

| 1 | | | | 2 | | | | 3 | | | |
|---|---|---|---|---|---|---|---|---|---|---|---|
| [symbol] | ↓ | [symbol] | ⊗ | [symbol] | ↓ | [symbol] | ⊗ | [symbol] | ↓ | [symbol] | ⊗ |
| 0% | 60% | 40% | 0% | 30% | 40% | 30% | 0% | 40% | 60% | 0% | 0% |
| 4 | | | | 5 | | | | 6 | | | |
| [symbol] | ↓ | [symbol] | ⊗ | [symbol] | ↓ | [symbol] | ⊗ | [symbol] | ↓ | [symbol] | ⊗ |
| 0% | 60% | 40% | 0% | 30% | 40% | 30% | 0% | 40% | 60% | 0% | 0% |
| 7 | | | | 8 | | | | 9 | | | |
| [symbol] | ↓ | [symbol] | ⊗ | [symbol] | ↓ | [symbol] | ⊗ | [symbol] | ↓ | [symbol] | ⊗ |
| 0% | 0% | 0% | 100% | 0% | 0% | 0% | 100% | 0% | 0% | 0% | 100% |

In the example of Table 4, the symbols under cell number 1 means there is a probability of 60% that a ball in cell number 1 will move vertically downwards towards cell number 4, a probability of 40% that a ball in cell number 1 will move rightside downwards towards cell number 5, a probability of 0% that a ball in cell number 1 will move leftside downwards (which is out of bound), and a 0% that a ball in cell number 1 will stop at cell one, since by default in this example, the ball must move through to the final layer to stop. In other words, cell 1 has an example outgoing probablity of 60% to cell 4 and an example outgoing probablity of 40% to cell 3 and the sum of outgoing probablities of cell 1 is unity or 1. In the example, intermediate cell 5 has an example incoming probability of 40% if the ball is current in cell 1, an example incoming probability of 40% if the ball is current in cell 2, and an example incoming probability of 40% if the ball is current in cell 3. On the other hand, cell 4 has an example incoming probability of 60% if the ball is current in cell 1, an example incoming probability of 30% if the ball is current in cell 2, and an example incoming probability of 0% if the ball is current in cell 3. When a ball is in intermediate cell 5, the next hop of the ball can be to an intermediate cell 4 or cell 6 or an exit cell 8, but not other cells. The example movement rules or transition rules are to resemble movement consistent with movements under apparent influence of garvity.

In this example, there are a total of 17 available paths for a ball to transmit through the three layers and the available paths are: 147, 157, 247, 257, 357; 148, 158, 248, 258, 268, 358, 368; 159, 259, 269, 359, 369, where the first digit refers to the cell number in the entry layer, the second digit refers to the cell number in the intermediate layer, and the third digit refers to the cell number in the final layer. For example, the path 147 means a path passing from cell 1 to cell 7 by transiting through cell 4.

The transition relationship and probability can be represented in the form of an example transition matrix as set out in Table 5 below.

TABLE 5
$P = [ \begin{matrix}0 \% & 0 \% & 0 \% & 60 \% & 40 \% & 0 \% & 0 \% & 0 \% & 0 \% \\ 0 \% & 0 \% & 0 \% & 30 \% & 40 \% & 30 \% & 0 \% & 0 \% & 0 \% \\ 0 \% & 0 \% & 0 \% & 0 \% & 40 \% & 60 \% & 0 \% & 0 \% & 0 \% \\ 0 \% & 0 \% & 0 \% & 0 \% & 0 \% & 0 \% & 60 \% & 40 \% & 0 \% \\ 0 \% & 0 \% & 0 \% & 0 \% & 0 \% & 0 \% & 30 \% & 40 \% & 30 \% \\ 0 \% & 0 \% & 0 \% & 0 \% & 0 \% & 0 \% & 0 \% & 40 \% & 60 \% \\ 0 \% & 0 \% & 0 \% & 0 \% & 0 \% & 0 \% & 100 \% & 0 \% & 0 \% \\ 0 \% & 0 \% & 0 \% & 0 \% & 0 \% & 0 \% & 0 \% & 100 \% & 0 \% \\ 0 \% & 0 \% & 0 \% & 0 \% & 0 \% & 0 \% & 0 \% & 0 \% & 100 \%\end{matrix} ]$

The example transition matrix of Table 5 has 81 entries which are arranged into 9 rows and 9 columns. In the example transition matrix, an entry P_{i,j} on row i and column j represents the probability that a ball at cell numbered i will move on to the cell numbered j. The example transition matrix is a probability matrix and each probability entry, which is a probability cell, is a discrete p probability value.

Table 5 when added with row and column numbers as depicted as Table 5A below would further assist.

TABLE 5A

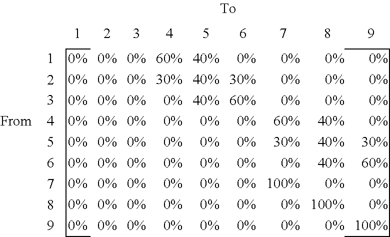

In the transition matrix of Table 4A, matrix element (i,j) represents the likelihood or probability that a ball will move from cell numbered i to cell numbered j. For example, the value of 60% at the transition matrix element (3,6) means there is a 60% that a ball at cell 3 will move to cell 6 in the next move, and the value of 40% at the transition matrix element (3,5) means there is a 40% that a ball at cell 3 will move to cell 5 in the next move. As the sum of probabilities of the transition matrix elements (3,5)and (3,6) equal unity, it follows that a ball at cell 3 can only move to either cell 5 or cell 6 in accordance with the prescribed rules and probabilities.

The probability that there is a ball at a cell numbered j is represented by a position probability array A below:

A=[a₁ a₂ a₃ a₄ a₅ a₆ a₇ a₈ a₉]

Where A is a position matrix that represents how balls are distributed, and the value of aⱼ, where j=1, 2, . . . , 9 is in percentage and between 0 and 1, that is, 0<=aⱼ<=1. An example probability array A=[0, 0, 0, 0, 0, 0, 0.1, 0.3, 0.6] means there is 10% probability that a ball is located at cell 7, a 30% probability at cell 8, and a 60% probability at cell 9. If there are 100 balls drop, on average, 10 balls would drop to cell 7, 30 balls would drop to cell 8 and 60 balls would drop to cell 9.

Where a ball has entered cell 1 following initial launch, the initial position matrix will be: A₀=[100%, 0, 0, 0,0, 0, 0, 0,0].

The ball distribution array Aₜ at time t will be: Aₜ=[aₜ₁, aₜ₂, aₜ₃, aₜ₄, aₜ₅, aₜ₆, aₜ₇, aₜ₈, aₜ₉]

Where:
P is the transition matrix, consisting of probability elements, P_{i,j}, representing the probability that a ball will transit between cells i and j.
A₀ represent the initial distribution (position).
Aₜ represents the position distribution for ball after time t, that is, t transitions.
aₜⱼ represents the probability that a ball will appear at cell j at time t.

For example, the relationship between A₀ and A₁, that is after one transition will be:

ti A₁=A₀·P=[a₁₁a₁₂a₁₃a₁₄a₁₅a₁₆a₁₇a₁₈a₁₉], where:

a₁₁=0×0+0×0+0×0+0×0+0×0+0×0+0×0+0×0+0×0=0

a₁₂=0×0+0×0+0×0+0×0+0×0+0×0+0×0+0×0+0×0=0

a₁₃=0×0+0×0+0×0+0×0+0×0+0×0+0×0+0×0+0×0=0

a₁₄=1×0.6+0×0.3+0×0+0×0+0×0+0×0+0×0+0×0+0×0=0.6

a₁₅=1×0.4+0×0.4+0×0.4+0×0+0×0+0×0+0×0+0×0+0×0=0.4

a₁₆=1×0+0×0.3+0×0.3+0×0+0×0+0×0+0×0+0×0+0×0=0

a₁₇=1×0+0×0+0×0+0×0.6+0×0.3+0×0+0×1+0×0+0×0=0

a₁₈=1×0+0×0+0×0+0×0.4+0×0.4+0×0.4+0×0+0×1+0×0=0

a₁₉=1×0+0×0+0×0+0×0+0×0.3+0×0.6+0×0+0×0+0×1=0

By applying principles of the Markov Chain, it will be noted that:

A₂=P·A₁=P·P·A₀=P²·A₀

It is further noted that when Aₜ₊₁=Aₜ, a stable situation has been reached. In this example, it is noted that:

A₀=[100% 0% 0% 0% 0% 0% 0% 0% 0%]

A₁=[0% 0% 0% 60% 40% 0% 0% 0% 0%]

A₂=[0% 0% 0% 0% 0% 0% 48% 40% 12%]

A₃=[0% 0% 0% 0% 0% 0% 48% 40% 12%]

Therefore, the model has stabilized at t=2. For example, by applying Aₜ₊₁=A₀·Pₜ, where a ball is initially in cell 1, there is 48% chance it will end at cell 7 after 2 unit time, 40% at cell 7 or 12% at cell 9.

### Lateral Movements Allowed

In further embodiments, a ball is allowed to move laterally within the same layer in addition to downward only movements as described in the above example. Using the same 9-cell model as a convenient example, and introducing two additional directions of lateral movements←and→, the available transit directions are depicted in table 6 below:

TABLE 6

| | Symbol | | | | | |
|---|---|---|---|---|---|---|
| | ← | [symbol] | ↓ | [symbol] | → | ⊗ |
| Meaning | Left | Left-Down | Down | Right-Down | Right | Stop |

The allowable movement directions as well as their example associated probabilities are depicted in table 7 below.

TABLE 7

| 1 | | | | | | 2 | | | | | | 3 | | | | | |
|---|---|---|---|---|---|---|---|---|---|---|---|---|---|---|---|---|---|
| ← | [symbol] | ↓ | [symbol] | → | ⊗ | ← | [symbol] | ↓ | [symbol] | → | ⊗ | ← | [symbol] | ↓ | [symbol] | → | ⊗ |
| 0% | 0% | 60% | 35% | 5% | 0% | 5% | 25% | 40% | 25% | 5% | 0% | 5% | 35% | 60% | 0% | 0% | 0% |
| 4 | | | | | | 5 | | | | | | 6 | | | | | |
| ← | [symbol] | ↓ | [symbol] | → | ⊗ | ← | [symbol] | ↓ | [symbol] | → | ⊗ | ← | [symbol] | ↓ | [symbol] | → | ⊗ |
| 0% | 0% | 60% | 35% | 5% | 0% | 5% | 25% | 40% | 25% | 5% | 0% | 5% | 35% | 60% | 0% | 0% | 100% |
| 7 | | | | | | 8 | | | | | | 9 | | | | | |
| ← | [symbol] | ↓ | [symbol] | → | ⊗ | ← | [symbol] | ↓ | [symbol] | → | ⊗ | ← | [symbol] | ↓ | [symbol] | → | ⊗ |
| 0% | 0% | 0% | 0% | 0% | 100% | 0% | 0% | 0% | 0% | 0% | 100% | 0% | 0% | 0% | 0% | 0% | 100% |

For example, in a predesigned or pre-allocated probability of Table 7 above, when a ball is in cell 1 after initial launch, there is a 60% pre-allocated chance that the ball will move downwards to cell 4, a 35% pre-allocated chance that the ball will move downwards and right to cell 5, and a 5% pre-allocated chance that the ball will move laterally to cell 2. The ball will continue to move until reaching a final cell having a 100% chance which means a final stop.

As the ball can now move laterally or horizontally in addition to along the other available paths described above, the number of available paths for transiting from an entry cell to a final cell would increase substantially. For example, it can take more than two transitions to reach the end cell or termination cell. For example, a ball can require 4 transitions to move from cell 1 (entry cell) to cell 7 (final cell) following the route: Cell1→Cell2→Cell5→Cell4→Cell7.

Mathematically, the possible movement paths can be represented by an example transition matrix below:

$$P = [ \begin{matrix}0 \% & 5 \% & 0 \% & 60 \% & 35 \% & 0 \% & 0 \% & 0 \% & 0 \% \\ 5 \% & 0 \% & 5 \% & 25 \% & 40 \% & 25 \% & 0 \% & 0 \% & 0 \% \\ 0 \% & 5 \% & 0 \% & 0 \% & 35 \% & 60 \% & 0 \% & 0 \% & 0 \% \\ 0 \% & 0 \% & 0 \% & 0 \% & 5 \% & 0 \% & 60 \% & 35 \% & 0 \% \\ 0 \% & 0 \% & 0 \% & 5 \% & 0 \% & 5 \% & 25 \% & 40 \% & 25 \% \\ 0 \% & 0 \% & 0 \% & 0 \% & 5 \% & 0 \% & 0 \% & 35 \% & 60 \% \\ 0 \% & 0 \% & 0 \% & 0 \% & 0 \% & 0 \% & 100 \% & 0 \% & 0 \% \\ 0 \% & 0 \% & 0 \% & 0 \% & 0 \% & 0 \% & 0 \% & 100 \% & 0 \% \\ 0 \% & 0 \% & 0 \% & 0 \% & 0 \% & 0 \% & 0 \% & 0 \% & 100 \%\end{matrix} ]$$

The position distribution for the 9 cells will be: A=[a₁a₂a₃a₄a₅a₆a₇a₈a₉].

Assuming that the ball is in cell 1 after initial launch, i.e., A₀=[100% 0% 0% 0% 0% 0% 0% 0% 0%].

The ball distribution probability at time t would be:

Aₜ=[aₜ₁, aₜ₂, aₜ₃, aₜ₄, aₜ₅, aₜ₆, aₜ₇, aₜ₈, aₜ₉]

Using the same symbols and conventions as above, and since Aₜ₊₁=Aₜ·P, it can be found that:

A₀=[100.00% 0.00% 0.00% 0.00% 0.00% 0.00% 0.00% 0.00% 0.00%]

A₁=[0.00% 5.00% 0.00% 60.00% 35.00% 0.00% 0.00% 0.00% 0.00%]

A₂=[0.25% 0.00% 0.25% 3.00% 5.00% 3.00% 44.75% 35.00% 8.75%]

A₃=[0.00% 0.03% 0.00% 0.40% 0.48% 0.40% 47.80% 39.10% 11.80%]

A₄=[0.00% 0.00% 0.00% 0.03% 0.05% 0.03% 48.16% 39.57% 12.16%]

A₅=[0.00% 0.00% 0.00% 0.00% 0.00% 0.00% 48.19% 39.61% 12.19%]

A₆=[0.00% 0.00% 0.00% 0.00% 0.00% 0.00% 48.19% 39.61% 12.19%]

As A₅=A₆, the transition will become stable at t=5. It is noted that by introducing the horizontal options in addition, the time to reach stability has been extended even though the number of cells, that is the size of the matrix remains unchanged.

### Hopping Allowed

In further examples, using the 9-identical cell example of Table 2 above, a ball in one cell is allowed to hop to another cell which is not in the directly surrounding vicinity. In other words, the ball can hop to another cell, independent of the layer to which the next destination cell belongs or coordinates of the next destination cell. To facilitate effective representation, an example probability table 7 below is used:

TABLE 8

| | Symbol | | | | | | | | |
|---|---|---|---|---|---|---|---|---|---|
| | To 1 | To 2 | To 3 | To 4 | To 5 | To 6 | To 7 | To 8 | To 9 |
| Meaning | Prob to | Prob to | Prob to | Prob to | Prob to | Prob to | Prob to | Prob to | Prob to |
| | go cell 1 | go cell 2 | go cell 3 | go cell 4 | go cell 5 | go cell 6 | go cell 7 | go cell 8 | go cell 9 |

The revised example probability distribution for each cell would be as depicted in Table 9 below:

TABLE 9

| | 1 | | | | | | | | | 2 | | | | | | | | | 3 | | | | | | | | |
|---|---|---|---|---|---|---|---|---|---|---|---|---|---|---|---|---|---|---|---|---|---|---|---|---|---|---|---|
| To | 1 | 2 | 3 | 4 | 5 | 6 | 7 | 8 | 9 | 1 | 2 | 3 | 4 | 5 | 6 | 7 | 8 | 9 | 1 | 2 | 3 | 4 | 5 | 6 | 7 | 8 | 9 |
| % | 0 | 5 | 0 | 59 | 35 | 0 | 0 | 0 | 1 | 5 | 0 | 5 | 25 | 39 | 25 | 0 | 0 | 1 | 0 | 5 | 0 | 0 | 35 | 59 | 0 | 0 | 1 |
| | 4 | | | | | | | | | 5 | | | | | | | | | 6 | | | | | | | | |
| To | 1 | 2 | 3 | 4 | 5 | 6 | 7 | 8 | 9 | 1 | 2 | 3 | 4 | 5 | 6 | 7 | 8 | 9 | 1 | 2 | 3 | 4 | 5 | 6 | 7 | 8 | 9 |
| % | 0 | 0 | 0 | 0 | 5 | 0 | 59 | 35 | 1 | 0 | 0 | 0 | 5 | 0 | 5 | 25 | 40 | 25 | 0 | 0 | 0 | 0 | 5 | 0 | 0 | 35 | 60 |
| | 7 | | | | | | | | | 8 | | | | | | | | | 9 | | | | | | | | |
| To | 1 | 2 | 3 | 4 | 5 | 6 | 7 | 8 | 9 | 1 | 2 | 3 | 4 | 5 | 6 | 7 | 8 | 9 | 1 | 2 | 3 | 4 | 5 | 6 | 7 | 8 | 9 |
| % | 0 | 0 | 0 | 0 | 0 | 0 | 100 | 0 | 0 | 0 | 0 | 0 | 0 | 0 | 0 | 0 | 100 | 0 | 0 | 0 | 0 | 0 | 0 | 0 | 0 | 0 | 100 |

As mentioned above, movement between home and next destination cells would not be limited by co-ordinates. For example, there is 1% chance for ball to move from cell 1 to cell 9 directly in 1 unit time, although the home and next destination cells are not in adjacency. As a result of the additional freedom and flexibility, the number of available paths would increase rapidly compared to the embodiments above.

The available paths can be represented by a transition matrix as set out in Table 10 below.

TABLE 10
$P = [ \begin{matrix}0 \% & 5 \% & 0 \% & 59 \% & 35 \% & 0 \% & 0 \% & 0 \% & 1 \% \\ 5 \% & 0 \% & 5 \% & 25 \% & 39 \% & 25 \% & 0 \% & 0 \% & 1 \% \\ 0 \% & 5 \% & 0 \% & 0 \% & 35 \% & 59 \% & 0 \% & 0 \% & 1 \% \\ 0 \% & 0 \% & 0 \% & 0 \% & 5 \% & 0 \% & 59 \% & 35 \% & 1 \% \\ 0 \% & 0 \% & 0 \% & 5 \% & 0 \% & 5 \% & 25 \% & 40 \% & 25 \% \\ 0 \% & 0 \% & 0 \% & 0 \% & 5 \% & 0 \% & 0 \% & 35 \% & 60 \% \\ 0 \% & 0 \% & 0 \% & 0 \% & 0 \% & 0 \% & 100 \% & 0 \% & 0 \% \\ 0 \% & 0 \% & 0 \% & 0 \% & 0 \% & 0 \% & 0 \% & 100 \% & 0 \% \\ 0 \% & 0 \% & 0 \% & 0 \% & 0 \% & 0 \% & 0 \% & 0 \% & 100 \%\end{matrix} ]$

Using the same conventions as above and since Aₜ₊₁=Aₜ·P, it is noted from Table 11 below that the operation will stabilize at t=5 where A₅=A₆.

Table 11

A₀=[100.00% 0.00% 0.00% 0.00% 0.00% 0.00% 0.00% 0.00% 0.00%]

A₁=[0.00% 5.00% 0.00% 59.00% 35.00% 0.00% 0.00% 0.00% 1.00%]

A₂=[0.25% 0.00% 0.25% 3.00% 4.90% 3.00% 43.56% 34.65% 10.39%]

A₃=[0.00% 0.03% 0.00% 0.39% 0.48% 0.39% 46.56% 38.71% 13.45%]

A₄=[0.00% 0.00% 0.00% 0.03% 0.05% 0.03% 46.91% 39.17% 13.81%]

A₅=[0.00% 0.00% 0.00% 0.00% 0.00% 0.00% 46.94% 39.22% 13.84%]

A₆=[0.00% 0.00% 0.00% 0.00% 0.00% 0.00% 46.94% 39.22% 13.84%]

Therefore, if additional freedoms of movements are allowed, the time to stability will increase. In the example embodiments, the time to stability swings from 1 to 5 between the first embodiment and the third embodiment and swings from 1 to 3 between the first and second embodiments.

### Hopping—Irregular Layers

In further example embodiments, still using the 9-cell model of table 1 above for simplicity, but with the 9 cells arranged in a non-rectangular manner or irregular shape as depicted in Table 12 below.

TABLE 12

| | | | | |
|---|---|---|---|---|
| Layer 1 | | 1 | 2 | |
| Layer 2 | 3 | 4 | 5 | 6 |
| Layer 3 | 7 | 8 | 9 | |

In the arrangement above, 9 identical cells are arranged into three rows, with two cells in the first row, four cells in the second row and 3 cells in the third row. The first row and the second rows are center aligned and the second and third rows are left edge aligned.

The revised example probability distributed would be as depicted in Table 13 below.

An example transition matrix for this model is depicted in Table 14 below.

TABLE 14
$P = [ \begin{matrix}0 \% & 9 \% & 25 \% & 40 \% & 25 \% & 0 \% & 0 \% & 0 \% & 1 \% \\ 9 \% & 0 \% & 0 \% & 25 \% & 40 \% & 25 \% & 0 \% & 0 \% & 1 \% \\ 0 \% & 0 \% & 0 \% & 5 \% & 0 \% & 0 \% & 59 \% & 35 \% & 1 \% \\ 0 \% & 0 \% & 5 \% & 0 \% & 5 \% & 0 \% & 25 \% & 40 \% & 25 \% \\ 0 \% & 0 \% & 0 \% & 5 \% & 0 \% & 5 \% & 0 \% & 35 \% & 55 \% \\ 0 \% & 0 \% & 0 \% & 0 \% & 10 \% & 0 \% & 0 \% & 0 \% & 90 \% \\ 0 \% & 0 \% & 0 \% & 0 \% & 0 \% & 0 \% & 100 \% & 0 \% & 0 \% \\ 0 \% & 0 \% & 0 \% & 0 \% & 0 \% & 0 \% & 0 \% & 100 \% & 0 \% \\ 0 \% & 0 \% & 0 \% & 0 \% & 0 \% & 0 \% & 0 \% & 0 \% & 100 \%\end{matrix} ]$

Using the same conventions as above and since Aₜ₊₁=Aₜ·P, it is noted from Table 15 below that the operation will stabilize at t=6 where A₆=A₇.

TABLE 15

| | | | | | | | | | |
|---|---|---|---|---|---|---|---|---|---|
| A₀= | [100.00% | 0.00% | 0.00% | 0.00% | 0.00% | 0.00% | 0.00% | 0.00% | 0.00%] |
| A₁= | [0.00% | 9.00% | 25.00% | 40.00% | 25.00% | 0.00% | 0.00% | 0.00% | 1.00%] |
| A₂= | [0.81% | 0.00% | 2.00% | 4.75% | 5.60% | 3.50% | 24.75% | 33.50% | 25.09%] |
| A₃= | [0.00% | 0.07% | 0.44% | 0.70% | 0.79% | 0.28% | 27.12% | 38.06% | 32.54%] |
| A₄= | [0.01% | 0.00% | 0.04% | 0.08% | 0.09% | 0.06% | 27.55% | 38.77% | 33.40%] |
| A₅= | [0.00% | 0.00% | 0.01% | 0.01% | 0.01% | 0.00% | 27.59% | 38.85% | 33.53%] |
| A₆= | [0.00% | 0.00% | 0.00% | 0.00% | 0.00% | 0.00% | 27.60% | 38.86% | 33.54%] |
| A₇= | [0.00% | 0.00% | 0.00% | 0.00% | 0.00% | 0.00% | 27.60% | 38.86% | 33.54%] |

### Launching

When a ball is launched by the launching device, whether the ball (as an example of a movable body) will land in a specific cell is dependent on a probability allocated to that cell plus other factors. That probability, also referred to as an “incoming probability” determines the likelihood that a launched ball will land in that entry layer cell. In other words, each of the cells on the entry layer has an associated probability and the probabilities of all the cells on the entry layer have a sum of unity, that is, the ball must land on one of the cells.

### Launching Angle

In some embodiments where the ball is launch by a launching device and the launching angle of the launching device or controller is adjustable, the incoming probability can be pre-designed or predetermined to be dependent on the cell number as well as the launch angle.

As depicted in FIGS. 4A and 4B, an example controller comprises a simulated control knob and a simulated cannon which are to appear on the display screen, for example, on lower left corner, on lower right corner, or split on both lower left and lower right corners. By rotating the control knob, angle of the simulated cannon with respect to a vertical axis or reference axis can be adjusted, and the launching angle can be selected at an angle which is within the angular range of the simulated cannon. As a convenient example, the launching angle of the example simulated cannon of FIG. 4B can be adjusted between, say, 0 to 35 degrees.

In embodiments where the entry layer is formed by an example plurality of 7 entry layer cells, each of the cell may have example pre-allocated probabilities or probability distribution with respect to a launching angle sub-range, as depicted in Table 1.

### Launching Force

In some embodiments, the user interface includes a force sensor to detect launching force applied by a user to the launching device. For example, the simulated cannon may be placed at the bottom righthand corner of the display device and connected to the sensor. The sensor may be calibrated to detect an example plurality of 7 quantized levels of force, and a probability distribution table similar to that of table 15 above can be devised, although with the example plurality of angular ranges on the first row replaced by the corresponding example plurality of quantized ranges of launching force.

When a ball or other types of movable body is launched from the launching device, the ball will follow a pre-devised simulated path to move from the launching device (that is, the cannon) to land in a destination entry layer cell which is determined with reference to the pre-allocated probabilities. To provide a more realistic view, the simulated path is devised to resemble a smooth trajectory path similar to a smooth trajectory path that can be expected by projecting a steel ball under gravity, such as that can be expected in conventional pachinko machines where real steel balls are projected from a launching tube and pass through a common space to enter a stage comprising a matrix of obstacles.

In some embodiments, the machine is equipped with an optional feature to reward a user for good performance, for example, by way of making a payout or bonus. The optional payouts may be devised according to a payout matrix to control the amount of payout with respect to the amount paid-in, so that the machine operator would not be expecting to make a loss in the medium to long-run, especially where the pay-in and payouts are in money, money-worth or kind based. In general, the relationship between long term pay-out and pay-in is usually characterized by a parameter known as “RTP” or “return-to-player”.

In some embodiments, the pay-in amount may be controlled by a user by selecting a ball of different colors to represent different power or strength. For example, by selecting a gold ball, the pay-in amount would be double to that of a steel ball and the rewards would be accordingly multiplied.

In example embodiments, each cell has an associated payout rate and the payout rates are set out in a payout matrix W, where W=[w₁, w₂, . . . , wₙ]^{T}, where n is the total number of active cells in the stage, and wᵢ is the payout rate associated with the i^{th} cell, where i and n are natural numbers.

For the 9-cell stage example, W=[w₁, w₂, . . . , wᵢ, . . . , w₉]^{T}

When in transposed form,

$$W = [ \begin{matrix}w 1 \\ w 2 \\ w 3 \\ w 4 \\ w 5 \\ w 6 \\ w 7 \\ w 8 \\ w 9\end{matrix} ]$$

The relationship between RTP and W, using the same conventions as above are as follows:

RTP=Aₜ·P·W=A₀·P^{t}·W

Using the example of Table 13, with the example that the ball is initially landed in cell 1, that is A₀=[1 0 0 0 0 0 0 0 0], and with the same transition matrix of Table 13, and with an example where payout distribution,

$$W = [ \begin{matrix}0 \\ 0 \\ 0 \\ 0 \\ 0 \\ 0 \\ 2 \\ 1 \\ 0\end{matrix} ] ,$$

which means a payout credit of 2 units will be awarded to the user when the ball lands in cell 7, a payout credit of 1 unit will be awarded to the user when the ball lands in cell 8, but will get no payout credit otherwise.

For this example, the movable ball stops moving after 6 transitions, and RTP=A₀·P⁶·W, that is:

$$= [ 1 \; 0 \; 0 \; 0 \; 0 \; 0 \; 0 \; 0 \; 0 ] \cdot [ \begin{matrix}0 \% & 9 \% & 25 \% & 40 \% & 25 \% & 0 \% & 0 \% & 0 \% & 1 \% \\ 9 \% & 0 \% & 0 \% & 25 \% & 40 \% & 25 \% & 0 \% & 0 \% & 1 \% \\ 0 \% & 0 \% & 0 \% & 5 \% & 0 \% & 0 \% & 59 \% & 35 \% & 1 \% \\ 0 \% & 0 \% & 5 \% & 0 \% & 5 \% & 0 \% & 25 \% & 40 \% & 25 \% \\ 0 \% & 0 \% & 0 \% & 5 \% & 0 \% & 5 \% & 0 \% & 35 \% & 55 \% \\ 0 \% & 0 \% & 0 \% & 0 \% & 10 \% & 0 \% & 0 \% & 0 \% & 90 \% \\ 0 \% & 0 \% & 0 \% & 0 \% & 0 \% & 0 \% & 100 \% & 0 \% & 0 \% \\ 0 \% & 0 \% & 0 \% & 0 \% & 0 \% & 0 \% & 0 \% & 100 \% & 0 \% \\ 0 \% & 0 \% & 0 \% & 0 \% & 0 \% & 0 \% & 0 \% & 0 \% & 100 \%\end{matrix} ] \cdot [ \begin{matrix}0 \\ 0 \\ 0 \\ 0 \\ 0 \\ 0 \\ 2 \\ 1 \\ 0\end{matrix} ]$$

For this example, the calculated RTP=94.059%. In general, the intended RTP can be set by adjusting or varying the value of elements W, A₀ and/or P.

In general, each 2-dimensional scene stage is pre-assigned a pre-determined characteristic transition matrix P, where

$$P = [ \begin{matrix}{p}_{11} & ⋯ & {p}_{1 j} \\ ⋮ & ⋱ & ⋮ \\ {p}_{i 1} & ⋯ & {p}_{ij}\end{matrix} ] ,$$

and pᵢⱼ is a probability representing the likelihood that a ball in cell numbered Twill next move to cell numbered j.

The position distribution matrix Aₜ at time t and the position matrix at time t+1 are related by the characteristic transition matrix P , such that Aₜ₊₁=Aₜ·P=[a_{t+1 1}, . . . , a_{t+1 i}], where Aₜ=[aₜ₁, aₜ₂, . . . , aₜⱼ] is a position distribution matrix that represents the position(s) of the ball(s) at time t, and

$${a}_{t + 11} = {\sum }_{r}^{j} {a}_{tr} {p}_{r 1}$$

aₜ₊₁ᵢ=Σᵣⁱaₜᵣpᵣᵢ·

As Aₜ₊₁=Aₜ·P, Aₜ=Aₜ₋₁·P, . . . , A₂A₁·P, A₁=A₀·P,

=>Aₜ₊₁A₀·P^{t}, ∀i, j, t which are non-negative integers and P is square matrix.

The distribution would be stabilized ultimately, that is, the ball would no longer move to another or next position, i.e. Aₜ=Aₜ₊ₜ as t→∞.

Therefore, the position of a ball at time t+1 can be found by its position at time t and the transition matrix P by Markov Chain operations.

A blank stage depicted in FIG. 5A comprises an example plurality of 5 cells, with cells numbered 1 to 7 forming an entry layer such that every movable body that is to enter the stage must land in one of cells 1 to 7 first and before proceeding further into the stage. In this example stage, cells numbered 11, 22, 23, 33, 35, 39 and 43 ae marked blue to each represent a type-one bonus or reward cell, cells numbered 45-51 are marked yellow to each represent a type-two bonus or reward cell, cells 38 and 44 are marked red to each represent a type-three bonus or reward cell, and cell numbered 44 is marked green to represent a type-four bonus or reward cell.

The available outgoing paths associated with each cell of the stage are depicted in FIG. 5B. It is noted that cells 38, 44-51 are end cells at which a ball will stay and not move on to another cell.

As depicted in FIG. 5C, windmills are devised in cells numbered 22, 23, 39, 43 as obstacle so that a movable body on landing in cells 22, 23, 39, 43 will have its movement direction deflected according to the movement possibilities as indicated by the arrows. As depicted in FIG. 5D, a shooter and a controller are devised and shown in the display device but outside the stage which is delineated by an oval boundary.

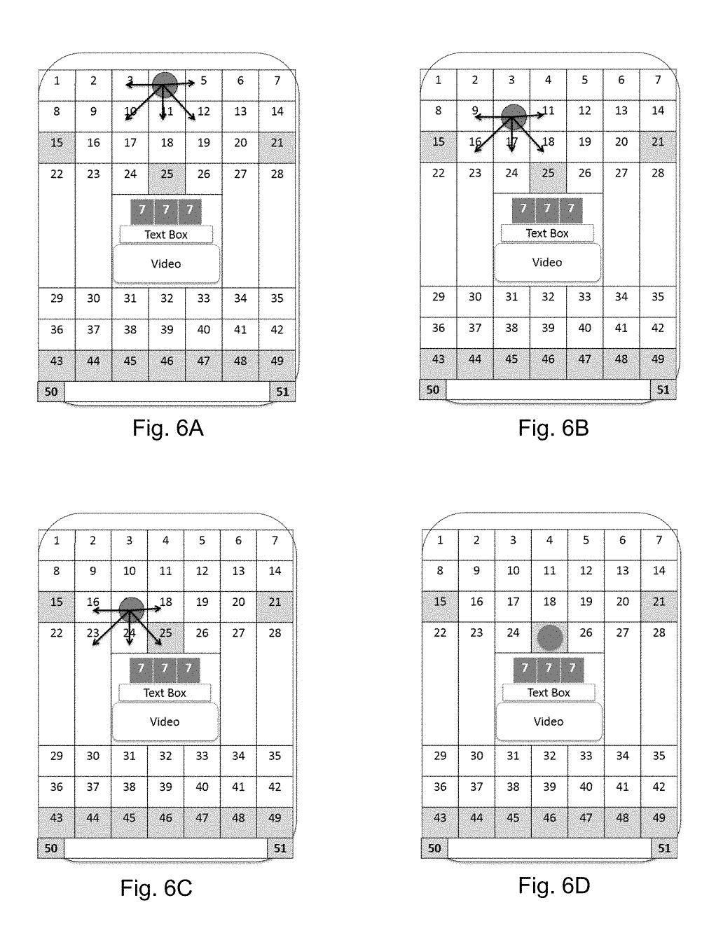

In an example operation as depicted in FIGS. 6A to 6D, an example simulated ball lands initially in cell number 4 after launch. At cell number 4, the next movement can be into cells 3, 5, 10, 11 or 12. The ball will move to cell 10 due to probability processing by the processor. Next, the ball will move to cell 17, also due to probability processing by the processor, and the ball finally move to cell 25 and make a major score and be rewarded. The probability that a ball can move from an entry layer cell, which is cell 4 in the present example, to an end cell, which is cell 25, is obtained by multiplication of the intervening probabilities and is very low. With the low probability, a higher reward commensurate with the predetermined RTP can be rewarded to encourage a player without loss of generality.

In an example operation as depicted in FIGS. 7A to 7J, an example plurality of 7 simulated balls are to enter into the stage by means of a single shot or a single launch. Progress of the plurality of simulated balls is to follow a predetermined probability, subject to resolution of conflicts of collision without loss of generality.

When the ball moves along the predetermined paths, the ball will have its movement path apparently deflected on encountering or colliding with the obstacle of a cell, and the ball will continue to move onto the next layer following the deflected path. The movement path of the ball is “apparently deflected” since the encounter is virtual and the deflected path was pre-determined according to predetermined rules at the time of launch. Although the encounter is virtual, the deflection path is designed and presented as if resulting from actual or physical encounters between the ball and the obstacle to produce more visually appealing and physically sensible effects.

An example simulated stage depicted in FIG. 8 is substantially based on the stage design of FIG. 5A. The stage is based on an example field matrix consisting of an example plurality of fifty field cells, numbered 1-50, arranged into 8 field rows and 7 field columns, as depicted in FIG. 5B. The cell partitioning boundaries and the cell numbers are also shown in

FIGS. 8A to 8C for ease of reference but the cell partitioning boundaries and the cell numbers may not be visible on actual running for aesthetic reasons.

Referring to FIG. 8A, an example simulated pachinko ball is ejected from a launcher having a ball launching outlet located on an upper right side of the display which his above and outside the active stage. An active stage herein means a stage delimited by the field cells. In this example, the simulated pachinko ball is ejected downwardly to enter an entry row at an acute entry angle with respect to the entry row. The ball appears to enter the entry region at a location intermediate the marks “3” and “4” but the location is within field cell numbered 4. The ball transits through the active stage along a transition path which is defined by cell numbers 4, 11, 10, 17, 22, 27, 34, 39 and 46. The path can be represented by a route description: 4→11→10→17→22→27→34→39→46. As depicted in the path, the ball is apparently deflected and changed its course on encountering the obstacle of cell 11, is guided along a path defined by the obstacles of cells 10 and 17, and then exits through exit cell 46. The cell marked 45 is a field cell that carries a special reward or bonus reward, while the location marked 51/52 is not an actual field cell but is a location that carries a special reward or bonus reward to raise RTP, and the ball will stop at that location. In addition, cells 34, 38 and 44 are trap locations where the ball will be trapped and stopped.

In the example of FIG. 8B, the ball is to transit along a path which is defined by cell numbers 3, 11, 12, 18, 23, 28, 36, and 43. The path can be represented by a route description: 3→11→12→18→23→28→36→43.

In the example of FIG. 8C, the ball is to transit along a path which is defined by cell numbers 6, 13, 18, 23, 28, 37, 44. The path can be represented by a route description: 6413418423428437444.

Similar to the other embodiments, the ball will land on an entry cell according to the launching parameters and the incoming probabilities of the entry cells, and the launching parameters include the angle or launch and/or the force level of the launch and other factors to be introduced from time to time. After entry into the stage, the subsequent transition path along which the ball will move depends on the transition probabilities. For example, the processor will operate a random number generator to determine the next immediate transition route according to the transition probabilities associated with an intermediate cell.

The example machine requires a pay-in amount to play and to launch a ball. The bet paid is shown on a lower right corner of the display screen, the cumulative credit or balance is shown on the lower right corner of the display screen and a push button for making a launch (for example, after the launching angle and launching force level have been set) is shown on the lower middle portion of the display screen. The user interface herein is by way of a touch screen and the push button is formed on the display screen during operations of the simulated pachinko machine. In some embodiments, the stage may be permanently set on a display surface of a display screen without loss of generality.

While the disclosure has been described with reference to the examples and embodiments, for example, the examples and embodiments described with reference to the Figures, it should be appreciated that the examples and embodiments are non-limiting examples only and are not to be used to restrict the scope of the present disclosure.

Table of numerals

| | | | |
|---|---|---|---|
| Apparatus (Machine) | 100 | | |
| Display screen | 110 | | |
| Display device | 112 | Display screen | 114 |
| Schematic playing field | 120 | | |
| Data storage device | 142 | Processor | 144 |
| Movable body | 162 | | |
| (Simulated pachinko ball) | | | |
| User interface | 164 | | |
| (Launching device) | | | |

1. A machine comprising a processor, a display device, a data storage device and a user interface, wherein the processor is to execute stored instructions:
to generate a simulated scene on the display device as a simulated playing field, wherein the simulated scene is divided into an entry region, an exit region and an intermediate region interconnecting the entry region and the exit region; wherein the entry region comprises a plurality of entry cells, the exit region comprises a plurality of exit cells, and the intermediate region comprises a plurality of intermediate cells; and
to generate one simulated object or a plurality of simulated objects on the display device, to launch a simulated object into the entry region as a launched object and to move the launched object through the intermediate region and then to exit via or on traversing through the exit region; and
wherein the processor is to execute stored instructions to move the launched object into one of the plurality of entry cells, wherein each entry cell has an associated entry probability which is predetermined and the plurality of entry cells has a sum of entry probabilities equals to one; wherein the launched object is to move through the simulated scene in one of a plurality of predetermined transition paths and each transition path is defined by a plurality of field cells each having associated incoming probabilities and outgoing probabilities which are predetermined; and wherein the incoming probabilities and outgoing probabilities are preset or prescribed in a predetermined transition probability matrix.

2. The machine according to claim 1, wherein the simulated playing field is divided or partitioned into a plurality of field cells arranged into a plurality of field rows and a plurality of field columns defining a field matrix, wherein the field matrix comprises an entry row, an exit row and an intermediate region which is intermediate the entry row and the exit row; wherein the intermediate region comprises one intermediate row or a plurality of intermediate rows; and wherein the transition probability matrix has a plurality of probability cells arranged into a plurality of probability rows and a plurality of probability columns; and wherein each probability cell has a corresponding field cell, each probability row has a corresponding field row and each probability column has a corresponding field column.

3. The machine according to claim 2, wherein the transition probability matrix has a plurality of probability cells, and wherein each probability cell has a pre-assigned discrete probability value.

4. The machine according to claim 3, wherein a plurality of the probability cells has a zero probability.

5. The machine according to claim 4, wherein the entry row comprises a plurality of entry cells, and wherein each entry cell has an assigned probability value and the assigned probability values of the entry cells forming the entry row has a sum equal to unity or 100%.

6. The machine according to claim 5, wherein the intermediate region comprises a proximal intermediate row which is immediately adjacent to or in abutment with the entry row, and the proximal intermediate row consists of a plurality of proximal intermediate cells; and wherein each proximal intermediate cell has an incoming probability value relating to a specific entry cell, and the incoming probability values of the plurality of proximal intermediate cells relating to the specific entry cell have a sum equal unity or 100%.

7. The machine according to claim 6, wherein the intermediate region comprises a distal intermediate row which is immediately adjacent to or in abutment with the exit row, and the distal intermediate row consists of a plurality of distal intermediate cells; and wherein each specific distal intermediate cell has an outgoing probability value associated with each exit cell, and the outgoing probability values of a specific distal intermediate cell in relation to the plurality of exit cells has a sum equal to unity or 100%.

8. The machine according to claim 1, wherein the machine comprises a simulated launcher which is to operate to launch a simulated object into the entry region at a launching angle and a launching force level, and wherein the simulated object is to land on an entry cell according to a predetermined entry probability; and wherein the predetermined entry probability associated with a specific entry cell is dependent on the launching angle and/or the launching force level.

9. The machine according to claim 8, wherein the entry probabilities of the plurality of entry cells change with a change in launching angles.

10. The machine according to claim 9, wherein the launching angle and/or the launching force level is user controllable or user adjustable.

11. The machine according to claim 1, wherein the intermediate region is populated with a plurality of simulated obstacles and the simulated obstacles are distributed to define the plurality of predetermined transition paths; and wherein the processor is to move the simulated object along one of the plurality of predetermined transition paths according to the probability matrix.

12. The machine according to claim 11, wherein the processor is to form an animation of the launched object as an object moving along a specific transition path and deflected by the obstacles on apparent collision encounters.

13. The machine according to claim 12, wherein the machine is a floor-standing pachinko machine comprising a floor-standing housing, the simulated playing filed is a simulated pachinko stage and the simulated objects are simulated pachinko balls which are to be launched into the simulated pachinko stage by a simulated launcher.

14. The machine according to claim 13, wherein the machine has an overall machine return-to-player rate and each entry cell has an entry cell return-to-player rate, and wherein the machine overall return-to-player rate relates to the incoming probabilities and return-to-zero rates of the entry cells.

15. The machine according to claim 14, wherein each launch requires a pay-in amount and each cell has an associated payout rate, and the payout rates of the cells forming the stage are predetermined.

16. The machine according to claim 15, wherein the incoming probabilities and the outgoing probabilities of a field cell in totality define a transition probability of a field cell, and the transition probability and the payout rates of the filled cells cooperate to define an RTP of the machine.

17. The machine according to claim 16, wherein the transition probabilities of all the filled cells are arranged in the form of a transition probability matrix and the payout rates of all the cells are arranged in the form of a payout matrix, wherein the total RTP is obtained by multiplying the transition probability matrix and the payout matrix or its transpose.

18. A method of devising a pachinko machine on a machine comprising a processor, a display device, a data storage device and a user interface, wherein the method comprises a processor executing stored instructions:
to generate a simulated scene on the display device as a simulated playing field, wherein the simulated scene is divided into an entry region, an exit region and an intermediate region interconnecting the entry region and the exit region; wherein the entry region comprises a plurality of entry cells, the exit region comprises a plurality of cells, and the intermediate region comprises a plurality of intermediate cells; and
to generate one simulated object or a plurality of simulated objects on the display device, to launch a simulated object into the entry region as a launched object and to move the launched object through the intermediate region and then to exit via or on traversing through the exit region; and
wherein the processor is to execute stored instructions to move the launched object into one of the plurality of entry cells upon receipt of a trigger signal, wherein each entry cell has an associated entry probability which is predetermined and the plurality of entry cells has a sum of entry probabilities equals to one; wherein the launched object is to move through the simulated scene in one of a plurality of predetermined transition paths and each transition path is defined by a plurality of field cells each having associated incoming probabilities and outgoing probabilities which are predetermined; and wherein the incoming probabilities and outgoing probabilities are preset or prescribed in a predetermined transition probability matrix.

19. The method according to claim 18, wherein the machine has an overall machine return-to-player rate and each entry cell has an entry cell return-to-player rate, and wherein the machine overall return-to-player rate relates to the incoming probabilities and return-to-zero rates of the entry cells.

20. The method according to claim 19, wherein each launch requires a pay-in amount and each cell has an associated payout rate, and the payout rates of the cells forming the stage are predetermined; and wherein the incoming probabilities and the outgoing probabilities of a field cell in totality define a transition probability of a field cell, and the transition probability and the payout rates of the filled cells cooperate to define an RTP of the machine.
